(19) United States
(12) Patent Application Publication
(10) Pub. No.: US 2016/0019486 A1
(43) Pub. Date: Jan. 21, 2016

(54) Resource Releasing Method, Apparatus, and System

(71) Applicant: Huawei Technologies Co., Ltd., Shenzhen (CN)

(72) Inventors: Jianhong Zeng, Shenzhen (CN); Kai Wang, Shenzhen (CN); Li Zhou, Wuhan (CN)

(21) Appl. No.: 14/869,144

(22) Filed: Sep. 29, 2015

Related U.S. Application Data
(63) Continuation of application No. PCT/CN2013/085421, filed on Oct. 18, 2013.

(30) Foreign Application Priority Data
Apr. 7, 2013 (CN) 201310117680.0

(51) Int. Cl. G06Q 10/06; H04L 29/06

(52) U.S. Cl. CPC G06Q 10/06314; H04L 67/42

(57) ABSTRACT

A resource releasing method, apparatus, and system. The method includes receiving, by a resource management server, a resource release request input by a user, where the request carries attribute information of a resource, and the resource is in a booked state; determining, by the resource management server, the corresponding resource according to the attribute information; sending, by the resource management server to a terminal, an instruction to acquire a current usage status of the resource; receiving, by the resource management server, current usage status information returned according to the instruction by the terminal; and releasing, by the resource management server, the resource when it is determined, according to the current usage status information, that the resource is not in use.

### CROSS-REFERENCE TO RELATED APPLICATIONS

This application is a continuation of International Application No. PCT/CN2013/085421, filed on Oct. 18, 2013, which claims priority to Chinese Patent Application No. 201310117680.0, filed on Apr. 7, 2013, both of which are hereby incorporated by reference in their entireties.

### TECHNICAL FIELD

The present invention relates to the communications field, and in particular, to a resource releasing method, apparatus, and system.

### BACKGROUND

In a modern society, as the scale of an enterprise grows, the number of its employees increases, which causes an increasing shortage of enterprise resources, especially for some exclusive resources, which are generally used by users who book them first, and consequently, the resources are unavailable for later users. When a user who first makes a booking does not use the resource or stops using the resource in advance, the resource is freed up. If the user does not release the resource in a timely manner, another user cannot learn about a current status of the resource, so that the resource cannot be used, thereby resulting in waste of the resource.

Taking a conference room resource as an example, a conference room is a special channel for communication between employees, and effective communication can be performed by using this special channel. As the scale of an enterprise continuously increases, conference rooms are becoming limited resources for the enterprise.

Currently, an enterprise generally allocates a conference room resource by means of a conference room booking. A specific process is that a user books a right of use of a conference room in a period of time on a resource management server. Once the user makes a booking, another user cannot book a right of use of the conference room in this period of time. However, in many cases, a conference is canceled by the user for some reasons and the conference room is not used; or the conference ends in advance, and the conference room is freed up. However, another user cannot learn about these cases, so that the conference room cannot be used, thereby wasting the conference room resource.

In view of this, how to improve resource utilization is an urgent problem to be resolved.

### SUMMARY

An objective of the present invention is to provide a resource releasing method, apparatus and system, so as to prevent waste of a resource and improve resource utilization.

According to a first aspect, an embodiment of the present invention provides a resource releasing method, where the method includes receiving, by a resource management server, a resource release request input by a user, where the request carries attribute information of a resource, and the resource is in a booked state; determining, by the resource management server, the corresponding resource according to the attribute information; sending, by the resource management server to a terminal, an instruction to acquire a current usage status of the resource; receiving, by the resource management server, current usage status information returned according to the instruction by the terminal; and releasing, by the resource management server, the resource when it is determined, according to the current usage status information, that the resource is not in use.

In a first possible implementation manner of the first aspect, the method further includes pushing, by the resource management server, prompt information to a terminal user, where the prompt information is used to query whether the terminal user books the released resource; and allocating, by the resource management server, the resource to the terminal user according to confirmation information returned by the terminal user.

With reference to the first possible implementation manner of the first aspect, in a second possible implementation manner, the resource management server stores subscription information of the resource, where the subscription information includes at least a subscriber; pushing, by the resource management server, prompt information to a terminal user is pushing, by the resource management server, the prompt information to the subscriber; and allocating, by the resource management server, the resource to the terminal user according to confirmation information returned by the terminal user is allocating, by the resource management server, the resource to the subscriber according to confirmation information returned by the subscriber.

With reference to the second possible implementation manner of the first aspect, in a third possible implementation manner, the resource management server stores priority information of the subscriber, and pushing, by the resource management server, the prompt information to the subscriber is pushing, by the resource management server, the prompt information to the subscriber according to the priority information.

With reference to the first aspect or any one of the first to third possible implementation manners of the first aspect, in a fourth possible implementation manner, sending, by the resource management server to a terminal, an instruction to acquire a current usage status of the resource is sending, by the resource management server to the terminal, an instruction to acquire the number of participants in a target conference room; receiving, by the resource management server, current usage status information returned according to the instruction by the terminal is receiving, by the resource management server, the number of participants in the target conference room returned according to the instruction by the terminal; and releasing, by the resource management server, the resource when it is determined, according to the current usage status information, that the resource is not in use is releasing, by the resource management server, the target conference room when it is determined that the number of participants is zero.

With reference to the fourth possible implementation manner of the first aspect, in a fifth possible implementation manner, releasing the target conference room when it is determined that the number of participants is zero includes releasing the target conference room when it is determined that, within a preset period of time, the number of participants is zero.

With reference to the fourth or fifth possible implementation manner of the first aspect, in a sixth possible implementation manner, there are at least two target conference rooms, and releasing the target conference room when it is determined that the number of participants is zero includes, when it is determined that the number of participants in a first conference room is zero and the number of participants in a second conference room is greater than zero, sending a release confirmation request to a terminal corresponding to the second conference room; and releasing the first conference room when a release confirmation instruction from the corresponding terminal is received.

With reference to the third possible implementation manner of the first aspect, in a seventh possible implementation manner, when the resource is a conference room resource, the method further includes determining, by the resource management server, a priority of the subscriber according to at least one piece of the following information: historical subscription credit of the subscriber, an office distance of the subscriber, and an urgency degree of a conference of the subscriber.

With reference to the first aspect or any one of the first to seventh possible implementation manners of the first aspect, in an eighth possible implementation manner, the current usage status information of the resource is obtained by the terminal in at least one of the following manners: image recognition, voice recognition, access control information, and information automatically input by a user.

According to a second aspect, an embodiment of the present invention further provides a resource releasing apparatus, including a request receiving unit configured to receive a resource release request input by a user, where the request carries attribute information of a resource, and the resource is in a booked state; a resource determining unit configured to determine the corresponding resource according to the attribute information; an instruction sending unit configured to send, to a terminal, an instruction to acquire a current usage status of the resource; a status information receiving unit configured to receive current usage status information returned according to the instruction by the terminal; and a resource releasing unit configured to release the resource when determining, according to the current usage status information, that the resource is not in use.

In a first possible implementation manner of the second aspect, the apparatus further includes a prompt information pushing unit configured to push prompt information to a terminal user, where the prompt information is used to query whether the terminal user books the released resource; and a resource allocating unit configured to allocate the resource to the terminal user according to confirmation information returned by the terminal user.

With reference to the first possible implementation manner of the second aspect, in a second possible implementation manner, the apparatus further includes a subscription information storage unit configured to store subscription information of the resource, wherein the subscription information comprises at least a subscriber, and wherein the prompt information pushing unit is configured to push the prompt information to the subscriber; and wherein the resource allocating unit is configured to allocate the resource to the subscriber according to confirmation information returned by the subscriber.

With reference to the second possible implementation manner of the second aspect, in a third possible implementation manner, the apparatus further includes a priority information storage unit configured to store priority information of the subscriber, wherein the prompt information pushing unit is configured to push the prompt information to the subscriber according to the priority information.

With reference to the second aspect or any one of the first to third possible implementation manners of the second aspect, in a fourth possible implementation manner, the instruction sending unit is configured to send, to the terminal, an instruction to acquire the number of participants in a target conference room; the status information receiving unit is configured to receive the number of participants in the target conference room returned according to the instruction by the terminal; and the resource releasing unit is configured to release the target conference room when determining that the number of participants is zero.

With reference to the fourth possible implementation manner of the second aspect, in a fifth possible implementation manner, the resource releasing unit is configured to release the target conference room when determining that, within a preset period of time, the number of participants is zero.

With reference to the fourth or fifth possible implementation manner of the second aspect, in a sixth possible implementation manner, there are at least two target conference rooms, and the resource releasing unit includes a request sending unit configured to, when determining that the number of participants in a first conference room is zero and the number of participants in a second conference room is greater than zero, send a release confirmation request to a terminal corresponding to the second conference room; and a status modifying subunit configured to release the first conference room when a release confirmation instruction from the corresponding terminal is received.

With reference to the third possible implementation manner of the second aspect, in a seventh possible implementation manner, when the resource is a conference room resource, the apparatus further includes a priority determining unit configured to determine a priority of the subscriber according to at least one piece of the following information: historical subscription credit of the subscriber, an office distance of the subscriber, and an urgency degree of a conference of the subscriber.

With reference to the second aspect or any one of the first to seventh possible implementation manners of the second aspect, in an eighth possible implementation manner, the current usage status information of the resource is obtained by the terminal in at least one of the following manners: image recognition, voice recognition, access control information, and information automatically input by a user.

According to a third aspect, an embodiment of the present invention further provides a resource releasing system, including a terminal and a resource management server, wherein the resource management server is configured to receive a resource release request input by a user and determine a corresponding resource according to attribute information, wherein the request carries the attribute information of the resource and wherein the resource is in a booked state; wherein the resource management server is further configured to send, to the terminal, an instruction to acquire a current usage status of the resource, receive current usage status information returned according to the instruction by the terminal, and release the resource when determining, according to the current usage status information, that the resource is not in use; and wherein the terminal is configured to receive the instruction, sent by the resource management server, to acquire the current usage status of the resource and further configured to acquire the current usage status information of the resource according to the instruction and send the current usage status information to the resource management server.

In a first possible implementation manner of the third aspect, the resource management server is further configured to push prompt information to a terminal user and allocate the resource to the terminal user according to confirmation information returned by the terminal user, wherein the prompt information is used to query whether the terminal user books the released resource.

With reference to the first possible implementation manner of the third aspect, in a second possible implementation manner, the resource management server is further configured to store subscription information of the resource, wherein the subscription information comprises at least a subscriber; and wherein the resource management server is configured to push the prompt information to the subscriber and allocate the resource to the subscriber according to confirmation information returned by the subscriber.

With reference to the second possible implementation manner of the third aspect, in a third possible implementation manner, the resource management server is further configured to store priority information of the subscriber, and the resource management server is configured to push the prompt information to the subscriber according to the priority information.

With reference to any one of the first to third possible implementation manners of the third aspect, in a fourth possible implementation manner, the resource management server is configured to send, to the terminal, an instruction to acquire the number of participants in a target conference room, receive the number of participants in the target conference room returned according to the instruction by the terminal, and release the target conference room when determining that the number of participants is zero.

With reference to the fourth possible implementation manner of the third aspect, in a fifth possible implementation manner, the resource management server is configured to release the target conference room when determining that, within a preset period of time, the number of participants is zero.

With reference to the fourth or fifth possible implementation manner of the third aspect, in a sixth possible implementation manner, there are at least two target conference rooms, and the resource management server is configured to, when determining that the number of participants in a first conference room is zero and the number of participants in a second conference room is greater than zero, send a release confirmation request to the terminal corresponding to the second conference room; and the resource management server is configured to release the first conference room when a release confirmation instruction from the terminal is received.

With reference to the second possible implementation manner of the third aspect, in a seventh possible implementation manner, when the resource is a conference room resource, the resource management server is further configured to determine a priority of the subscriber according to at least one piece of the following information: historical subscription credit of the subscriber, an office distance of the subscriber, and an urgency degree of a conference of the subscriber.

With reference to the third aspect or any one of the first to seventh possible implementation manners of the second aspect, in an eighth possible implementation manner, the current usage status information of the resource is obtained by the terminal in at least one of the following manners: image recognition, voice recognition, access control information and information automatically input by a user.

According to the specific embodiments provided in the present invention, the present invention achieves the following technical effect.

According to the method in the present invention, a booked resource is automatically released when a resource management server determines that the booked resource is not in use, such that another user may use the resource, thereby preventing waste of a resource and improving resource utilization.

### BRIEF DESCRIPTION OF DRAWINGS

To describe the technical solutions in the embodiments of the present invention more clearly, the following briefly introduces the accompanying drawings required for describing the embodiments. The accompanying drawings in the following description show merely some embodiments of the present invention, and a person of ordinary skill in the art may still derive other drawings from these accompanying drawings without creative efforts.

FIG. 1 is a flowchart of a method according to Embodiment 1 of the present invention;

FIG. 2 is a flowchart of a method according to Embodiment 2 of the present invention;

FIG. 3 is a priority weighting list according to the present invention;

FIG. 4 is a structural diagram of an apparatus according to Embodiment 3 of the present invention;

FIG. 5 is a flowchart of a method according to Embodiment 5 of the present invention;

FIG. 6 is a structural diagram of an apparatus according to Embodiment 6 of the present invention; and

FIG. 7 is a schematic diagram of resource management according to the present invention.

### DESCRIPTION OF EMBODIMENTS

The following clearly describes the technical solutions in the embodiments of the present invention with reference to the accompanying drawings in the embodiments of the present invention. The described embodiments are merely some but not all of the embodiments of the present invention. All other embodiments obtained by a person of ordinary skill in the art based on the embodiments of the present invention without creative efforts shall fall within the protection scope of the present invention.

First, terms in the following embodiments of the present invention are explained with reference to FIG. 7.

A booker refers to a user who books on a resource management platform of a resource management server, a resource in advance. For example, A books, on a conference resource management server, a right of use of a conference room 1 from 10 to 12 o'clock on Monday; then A is a booker of the right of use of the conference room 1 from 10 to 12 o'clock on Monday. When making a booking, a user may implement the booking by logging in to a resource management platform to query an idle resource and select the idle resource. In the present invention, a resource features exclusiveness, and therefore there is only one booker.

A subscriber refers to a user who subscribes to a booked resource. An idea of setting the subscriber is that, when a booker does not use a booked resource for some reason, the subscriber may have precedence over a common user in booking the resource.

In the foregoing example, if B subscribes, on the resource management platform, to the right of use of the conference room 1 from 10 to 12 o'clock on Monday, when the user A releases the right of use of the conference room 1 from 10 to 12 o'clock on Monday for some reason, that is, sets a status of the conference room 1 to idle, B may have precedence over a common user in becoming a booker of the right of use of the conference room 1 from 10 to 12 o'clock on Monday. In the present invention, there may be multiple subscribers, for example, C may also subscribe to the right of use of the conference room 1 from 10 to 12 o'clock on Monday. In order to prevent malicious subscription, it may be prescribed that one resource can have only a specified number of subscribers, or one subscriber can subscribe to only a specified number of resources.

Referring to FIG. 7, when the resource is a conference room resource, a participant, that is, a person who participates in a conference in a conference room during a period of time, may further be included.

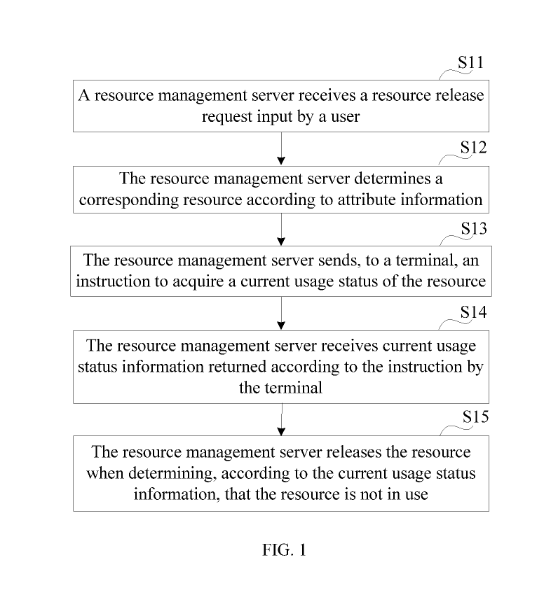

Referring to FIG. 1, FIG. 1 shows a resource releasing method provided in Embodiment 1 of the present invention, and the method includes the following steps.

S11: A resource management server receives a resource release request input by a user, where the request carries attribute information of a resource.

The resource management server is configured to manage a resource by using a resource management platform, such as booking, subscribing to, and releasing the resource.

S12: The resource management server determines the corresponding resource according to the attribute information. In the present invention, the user triggers, by sending the resource release request, a process in which the resource management server releases the resource, where the request carries the attribute information, such as resource identifier and a resource status, that is used by the resource management server to determine the resource.

In one of the embodiments, the user may send, to the resource management server, a request for releasing any resource, such as a request for releasing a resource in a booked state or a non-booked state.

In order to save a resource, in another optional embodiment, the user may send a request for releasing a resource in a booked state to the resource management server.

If the attribute information in the request sent by the user indicates that the resource is all resources in a booked state, the resource management server detects, according to the attribute information, all the resources that are currently in the booked state, and determines that the resources are resources to be released.

However, sometimes the user is interested in only a specific resource, and even though another resource other than the resource is released, the user does not book the other resource. Therefore, the user may add identification information of one or more specific resources to the request. The resource management server determines, according to the identification information, the one or more resources to be released.

S13: The resource management server sends, to a terminal, an instruction to acquire a current usage status of the resource.

The resource management server may send, in real time to the terminal, the instruction to acquire the current usage status of the resource. It should be noted that, terminals corresponding to different resources may be different, and the resource management server needs to determine a corresponding terminal according to a targeted resource.

S14: The resource management server receives current usage status information returned according to the instruction by the terminal.

After receiving the instruction, the terminal may acquire the current usage status of the resource and generate the current usage status information, and send the current usage status information to the resource management server.

The terminal may acquire the current usage status information of the resource in at least one of the following manners: image recognition, voice recognition, access control information, and information automatically input by a user.

S15: The resource management server releases the resource when determining, according to the current usage status information, that the resource is not in use.

In the present invention, releasing refers to setting a resource to be in an idle state. The resource management server may set, on the resource management platform, a status of the resource to the idle state. In this way, the user may book the resource.

In order to prevent mistakenly releasing a resource due to an error in determining, in the present invention, when determining, according to the current usage status information, that the resource is not in use, the resource management server may further send request information to a booker of the resource to query whether the booker uses the resource, and release the resource when determining, according to received information, that the booker does not use the resource any longer.

In fact, in the present invention, before the resource management server sends the instruction to the terminal, the resource management server may send the request information to the booker of the resource in advance, and release the resource when determining that the resource is not in use; the resource management server may consider by default that the booker does not use the resource when the booker makes no response, and release the resource.

According to the foregoing technical solution, the resource can be automatically released when the resource is booked but actually not in use, so that the resource can be booked again and used by another user, which, compared with the prior art, prevents waste of the resource and improves resource utilization.

In the prior art, if a user wants to learn about a status of a resource, the user needs to proactively log in to a resource management system to perform a query. Therefore, even though a resource is proactively released by a booker or is released by using the method described in the foregoing embodiment, the user may not learn about information that the resource is released if the user does not proactively perform a query; or the user finds, by means of multiple repeated queries, that resources are all in a booked state. The foregoing manner needs to consume a large amount of time of the user and a large number of resources. Therefore, the method in Embodiment 1 of the present invention further includes pushing, by the resource management server, prompt information to a terminal user when the resource is released, where the prompt information includes information about the released resource and is used to query whether the terminal user books the released resource.

In the present invention, the resource management server may acquire information about the terminal user in various manners. For example, information about an employee of an enterprise is acquired by using an employee information table, and the prompt information is pushed to the employee that is regarded as the terminal user. Pushing may be implemented in various manners, such as by using an email, a short message, or a voice service platform.

If confirmation information returned by the terminal user is received, the resource management server allocates the resource to the terminal user. It may be determined, on the resource management platform, that the terminal user is a booker.

However, different users have different requirements on resources, and therefore not all users want to obtain status information of a resource. In view of this, the present invention introduces a subscription mechanism. That is, after a resource is booked, another user is allowed to subscribe to the resource and becomes a subscriber. Obviously, the subscriber wants to obtain status information of the subscribed resource.

Corresponding to the foregoing situation, in the present invention, the resource management server may push the prompt information to the subscriber, and allocate the resource to the subscriber after receiving confirmation information returned by the subscriber.

The resource management platform of the resource management server stores subscription information, and the resource management server may learn about the subscriber corresponding to the resource according to the information.

As described above, there may be multiple subscribers; therefore, after pushing the prompt information, the resource management server may receive confirmation information returned by the multiple subscribers. In order to properly allocate the resource, in the present invention, priorities may be determined for the subscribers, and the resource management server may push the prompt information to the subscribers according to priority information of the subscribers. The prompt information is pushed to the subscribers according to priorities in descending order. If a subscriber with a higher priority does not return confirmation information, the prompt information is subsequently pushed to a subscriber with a lower priority until a subscriber returns confirmation information.

The priority information of the subscribers may be determined based on multiple factors, which is described in the following embodiment of the present invention.

In order to make the present invention clearer, the following uses a conference room resource as an example to describe the technical solution of the present invention in detail.

In the prior art, a booking of the conference room resource is managed by using a conference room resource management platform, which records booking information of a conference room in a period of time. A user can query whether the conference room resource is booked by logging in to the conference room resource management platform.

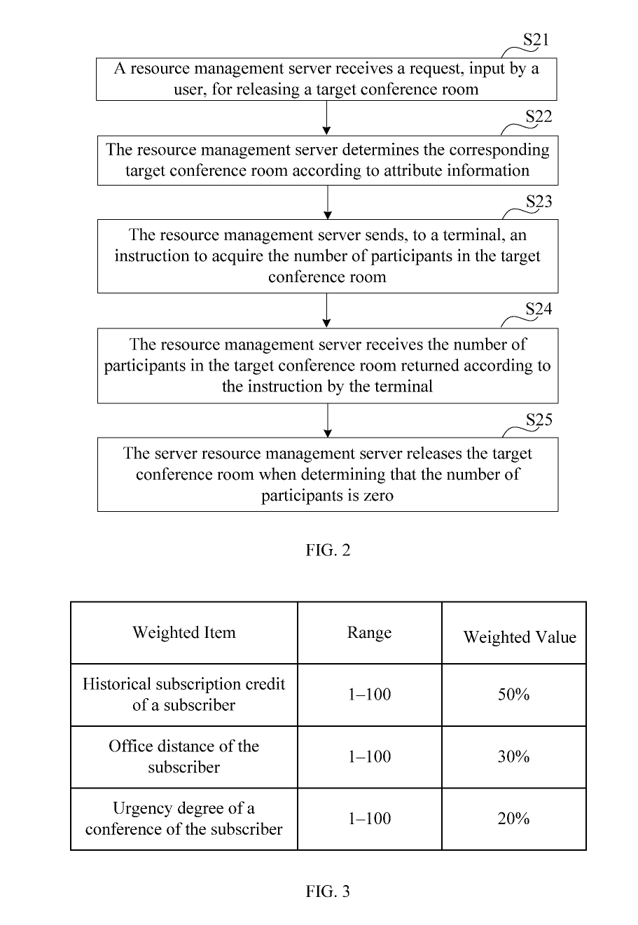

Referring to FIG. 2, FIG. 2 shows a resource releasing method provided in Embodiment 2 of the present invention, and the method includes the following steps.

S21: A resource management server receives a request, input by a user, for releasing a target conference room, where the request carries attribute information of the target conference room, and the target conference room is in a booked state. The attribute information may be a name, a room number, or the like of the conference room.

S22: The resource management server determines the corresponding target conference room according to the attribute information.

S23: The resource management server sends, to a terminal, an instruction to acquire the number of participants in the target conference room.

Whether a conference room is in use can be determined according to the number of participants. Therefore, in the present invention, the resource management server sends, to the terminal, the instruction to acquire the number of participants in the target conference room.

The target conference room may be determined by the resource management server itself, for example, the resource management server determines that a conference room booked for a current period of time is the target conference room; or the target conference room may be determined by the resource management server according to a request of a user, for example, a user sends a request for querying a current usage status of a conference room, and the resource management server may accordingly determine that the requested conference room is the target conference room.

S24: The resource management server receives the number of participants in the target conference room returned according to the instruction by the terminal.

The terminal acquires the number of participants in the target conference room according to the received instruction, and returns the number of participants to the resource management server.

S25: The resource management server releases the target conference room when determining that the number of participants is zero.

That the number of participants is zero indicates that nobody participates in a conference at the moment, and the resource management server may accordingly release the target conference room, and modify a status, in a conference resource management server, of the target conference room to an idle state, so that another user makes a booking.

It should be noted that, the number of participants being zero at a moment may be caused by an adjournment or a temporary delay of a conference. Therefore, in the present invention, the resource management server may release the target conference room when determining that the number of participants returned within a predetermined time is zero.

In an enterprise, a conference generally needs to occupy multiple conference rooms. For example, in a video conference between different departments, each department occupies one conference room; in this case, multiple conference rooms communicate with each other and know each other relatively well. Corresponding to this situation, in the present invention, when it is determined that the number of participants in a conference room is zero, a release confirmation request may be sent to a terminal corresponding to a conference room related to the conference room.

When there are at least two target conference rooms, and when determining that the number of participants in a first conference room is zero and the number of participants in a second conference room is greater than zero, the resource management server sends a release confirmation request to a terminal corresponding to the second conference room.

When a release confirmation instruction from the corresponding terminal is received, the resource management server releases the first conference room, and modifies, on the conference resource management server, a status of the first conference room to an idle state.

According to the foregoing technical solution, a conference room resource that is not in use is proactively released. In order to enable a user to learn about the information in a timely manner, this embodiment of the present invention further includes pushing, by the resource management server, prompt information to a terminal user when the resource is released, where the prompt information includes information about the released conference room resource, and is used to query whether the terminal user books the released conference room resource.

As described above, the resource management server may acquire information about the terminal user in various manners. For example, information about an employee of an enterprise is acquired by using an employee information table, and the prompt information is pushed to the employee that is regarded as the terminal user. Pushing may be implemented in various manners, such as by using an email, a short message, or a voice service platform.

If confirmation information returned by the terminal user is received, the resource management server allocates the conference room resource to the terminal user. It may be determined, on a resource management platform, that the terminal user is a booker.

However, different users have different requirements on resources, for example, a user A wants to book a right of use of a conference room 1 from 10 to 12 o'clock, a user B wants to book a right of use of a conference room 2 from 10 to 12 o'clock, and a user C wants to book a right of use of the conference room 1 from 14 to 16 o'clock; therefore, not all users want to obtain status information of a conference room resource. In view of this, the present invention introduces a subscription mechanism. That is, after a conference room resource is booked, another user is allowed to subscribe to the conference room resource and becomes a subscriber. Obviously, the subscriber wants to obtain status information of the subscribed conference room resource.

Corresponding to the foregoing situation, in the present invention, the resource management server may push the prompt information to the subscriber, and allocate the conference room resource to the subscriber after receiving confirmation information returned by the subscriber.

The resource management platform of the resource management server stores subscription information, and the resource management server may learn about the subscriber corresponding to the conference room resource according to the information.

For example, the resource management server releases the conference room resource of the conference room 1 from 14 to 16 o'clock by using the foregoing method, and finds, by checking a record of the conference resource management server, that A subscribes to the conference room 1 from 10 to 12 o'clock, B subscribes to the conference room 2 from 10 to 12 o'clock, and the user C subscribes to conference room 1 from 14 to 16 o'clock. Therefore, prompt information that indicates the conference room 1 from 14 to 16 o'clock is released and queries whether the user C books the resource is pushed to the user C. When the confirmation information from the user C is received, it is determined that a booker of the conference room 1 from 14 to 16 o'clock is the user C.

Sometimes, there are multiple subscribers for one resource. For example, in the foregoing example, the resource management server further finds that a user D also subscribes to the conference room 1 from 14 to 16 o'clock. In this case, the resource management server may push the prompt information to a subscriber selected according to a sequence of subscription time; or the resource management server may push the prompt information to a randomly selected subscriber and send the prompt information to a next subscriber when no confirmation information is received; or the resource management server pushes the prompt information to all subscribers, and allocates the resource to a subscriber who first replies with confirmation information. However, in order to further improve resource utilization, in the present invention, priorities may be determined for the subscribers, and the resource management server pushes the prompt information to the subscribers according to the priorities. The resource management server first pushes the prompt information to a subscriber with a higher priority, and if confirmation information is received, the resource management server allocates the resource to the subscriber. If no confirmation information is received, the resource management server pushes the prompt information to a subscriber with a lower priority until confirmation information is received.

The priority information of the subscribers may be determined based on multiple factors. In the present invention, the priority information may be determined based on at least one of the following factors: historical subscription credit of the subscribers, office distances of the subscribers, and urgency degrees of conferences of the subscribers.

A priority of a subscriber may be determined by using a method of weighting each factor. For example, as shown in FIG. 3, there are weighted items such as historical subscription credit of a subscriber, an office distance of the subscriber to a conference room, and an urgency degree of a conference of the subscriber, and their weighted values are 50 percent (%), 30%, and 20% respectively. Each weighted item is represented by a score, which may be determined by using an initial value and a specific situation of each weighted item.

For example, the historical subscription credit of the subscriber may be determined by using historical utilization of a booked conference room of the subscriber. A point deduction mechanism may be used, and specific implementation is as follows.

The following are point deduction events.

1. Booking a conference room, normally starting using the conference room, but closing a conference in advance. A specific point may be determined according to a time for which the conference is closed in advance. For example, 1 point is deducted when the conference is closed 30 minutes in advance; 2 points are deducted when the conference is closed 60 minutes in advance, and so on.

2. Booking a conference room, but arriving late. A specific point may be determined according to a time for which the subscriber is late. For example, 1 point is deducted if the subscriber is late for 10 minutes, and so on.

3. Booking a conference room, but skipping using it. 5 points are deducted if the conference room is not used.

The following are point earning events.

1 point is awarded if a booked conference room is released one or more days in advance by using a conference management system when it is determined that the conference room is no longer used.

A historical subscription credit score of a subscriber may be set to 100 in an initial state, and a current credit score of the subscriber is determined by using the foregoing mechanism.

An office distance of a subscriber refers to a distance from an office location of the subscriber to a booked conference room. Information about the location of the subscriber may be acquired in many manners. For example, the subscriber explicitly registers the office location of the subscriber during the registration, or a physical location of the subscriber can be dynamically recognized by using a Windows domain management mechanism.

Conferences are categorized into emergency conferences, general conferences, and non-emergency conferences according to an urgency degree. A more urgent conference has a higher score.

Scores of each weighted item may be determined by using the foregoing method, and then a priority of the subscriber may be obtained with reference to the weighted value of each weighted item.

The following is a specific application scenario of the present invention.

The conference room 1 is booked for 10 to 12 o'clock, and the resource management server sends, to a terminal in the conference room 1, an instruction to acquire a current usage status of the conference room resource.

The terminal recognizes, by using a camera, that there are 5 participants, and returns the information about the number of participants to the resource management server.

After one hour of the conference, the terminal recognizes, by using the camera, that there is no participant, and returns the information about the number of participants to the resource management server.

The resource management server records a time at which the number of participants being zero is received for the first time; and continues receiving the number of participants returned by the terminal, and also records a time of reception.

The resource management server detects, according to the recorded time, that the received number of participants is zero for 10 minutes, and therefore releases the conference room resource and modifies a status of the conference room 1 to an idle state for 10 to 12 o'clock; or further, the resource management server modifies a status of the conference room 1 to an idle state from a release moment to 12 o'clock.

In the foregoing process, the resource management server may acquire information about the booker when the received number of participants is zero for 10 minutes, send request information to the booker, and release the conference room resource when receiving confirmation from the booker that the conference room resource is not used any longer.

When detecting that a conference room resource is released, the resource management server first traverses a conference room resource management platform to acquire a list C1 of subscribers in a waiting state, and acquires a list C2 in the conference room resource management platform, where the list C2 records related information, such as historical subscription credit, an office distance and an urgency degree of a conference, of each subscriber; the resource management server accordingly sorts priorities of the subscribers to acquire a priority list C3.

The resource management server selects a subscriber with a highest priority according to the list C3, and notifies the subscriber by using a short message (or an electronic mail (email)) and queries whether the subscriber books the conference room resource.

The subscriber with the highest priority replies the resource management server with information that the subscriber does not book the conference room resource; the resource management server selects, according to the list C3, a subscriber with a lower priority, and notifies the subscriber by using a short message (or an email) and queries whether the subscriber books the conference room resource.

The subscriber with the lower priority replies the resource management server with information that the subscriber books the conference room resource; the resource management server determines, on the conference room resource management platform, that the subscriber with the lower priority is the booker of the resource.

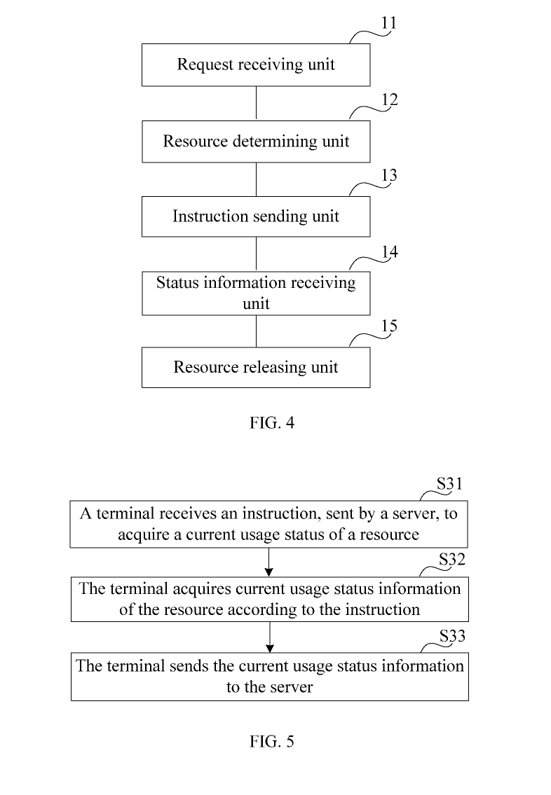

Corresponding to the foregoing methods, Embodiment 3 of the present invention provides a resource releasing apparatus. Referring to FIG. 4, the apparatus includes a request receiving unit 11, a resource determining unit 12, an instruction sending unit 13, a status information receiving unit 14, and a resource releasing unit 15.

The request receiving unit 11 is configured to receive a resource release request input by a user, where the request carries attribute information of a resource.

The resource determining unit 12 is configured to determine the corresponding resource according to the attribute information. In the present invention, the user triggers, by sending the resource release request, a process in which a resource management server releases the resource, where the request carries the attribute information, such as resource identifier and a resource status, that is used by the resource management server to determine the resource.

In one of the embodiments, the user may send, to the resource management server, a request for releasing any resource, such as a request for releasing a resource in a booked state or a non-booked state.

In order to save a resource, in another optional embodiment, the user may send a request for releasing a resource in a booked state to the resource management server.

If the attribute information in the request sent by the user indicates that the resource is all resources in a booked state, the resource determining unit detects, according to the attribute information, all the resources that are currently in the booked state, and determines that the resources are resources to be released.

However, sometimes the user is interested in only a specific resource, and even though another resource other than the resource is released, the user does not book the other resource. Therefore, the user may add identification information of one or more specific resources to the request. The resource determining unit determines, according to the identification information, the one or more resources to be released.

The instruction sending unit 13 is configured to send, to a terminal, an instruction to acquire a current usage status of the resource.

The status information receiving unit 14 is configured to receive current usage status information returned according to the instruction by the terminal.

The terminal may acquire the current usage status information of the resource in at least one of the following manners: image recognition, voice recognition, access control information, and information automatically input by a user.

The resource releasing unit 15 is configured to release the resource when determining, according to the current usage status information, that the resource is not in use.

In the present invention, releasing refers to setting a resource to be in an idle state. The resource releasing unit may set, on a resource management platform, a status of the resource to the idle state. In this way, the user may book the resource.

In order to prevent mistakenly releasing a resource due to an error in determining, the apparatus in the present invention further includes a request information sending unit, which is configured to send request information to a booker of the resource when the resource releasing unit determines, according to the current usage status information, that the resource is not in use, where the request information is used to query whether the booker uses the resource; the resource releasing unit is configured to release the resource when determining, according to received information, that the booker does not use the resource any longer.

In fact, in the present invention, before the instruction sending unit sends the instruction to the terminal, the request information sending unit may send the request information to the booker of the resource in advance; the resource releasing unit is configured to release the resource when determining that the resource is not in use. The resource releasing unit is further configured to release the resource when the booker makes no response.

According to the foregoing technical solution, the resource can be automatically released when the resource is booked but actually not in use, so that the resource can be booked again and used by another user, which, compared with the prior art, prevents waste of the resource and improves resource utilization.

In the prior art, if a user wants to learn about a status of a resource, the user needs to proactively log in to a resource management system to perform a query. Therefore, even though a resource is proactively released by a booker or is released by using the method described in the foregoing embodiment, the user may not learn about information that the resource is released if the user does not proactively perform a query; or the user finds, by means of multiple repeated queries, that resources are all in a booked state. The foregoing manner needs to consume a large amount of time of the user and a large number of resources. Therefore, the apparatus in Embodiment 3 of the present invention further includes a prompt information pushing unit configured to push prompt information to a terminal user when the resource is released, where the prompt information includes information about the released resource, and is used to query whether the terminal user books the released resource; and a resource allocating unit configured to allocate the resource to the terminal user according to confirmation information returned by the terminal user. It may be determined, on the resource management platform, that the terminal user is a booker.

However, different users have different requirements on resources, and therefore not all users want to obtain status information of a resource. In view of this, the present invention introduces a subscription mechanism. That is, after a resource is booked, another user is allowed to subscribe to the resource and becomes a subscriber. Obviously, the subscriber wants to obtain status information of the subscribed resource.

Corresponding to the foregoing situation, the apparatus in the present invention further includes a subscription information storage unit, which is configured to store subscription information of the resource, where the subscription information includes at least a subscriber.

The prompt information pushing unit is configured to push the prompt information to the subscriber.

The resource allocating unit is configured to allocate the resource to the subscriber according to confirmation information returned by the subscriber.

As described above, there may be multiple subscribers; therefore, after the prompt information is pushed, confirmation information returned by the multiple subscribers may be received. In order to properly allocate the resource, the apparatus in the present invention further includes a priority information storage unit, which is configured to store priority information of the subscribers. The prompt information pushing unit is configured to push the prompt information to the subscribers according to the priority information.

The prompt information pushing unit pushes the prompt information to the subscribers according to priorities in descending order. If a subscriber with a higher priority does not return confirmation information, the prompt information pushing unit subsequently pushes the prompt information to a subscriber with a lower priority until a subscriber returns confirmation information.

The priority information of the subscribers may be determined based on multiple factors, which is described in the following embodiment of the present invention.

The following uses a conference room resource as an example to describe the technical solution of the present invention in detail.

In the prior art, a booking of the conference room resource is managed by using a conference room resource management platform, which records booking information of a conference room in a period of time. A user can query whether the conference room resource is booked by logging in to the conference room resource management platform.

Embodiment 4 of the present invention provides a resource releasing apparatus, including a request receiving unit, a resource determining unit, an instruction sending unit, a status information receiving unit, and a resource releasing unit.

The request receiving unit is configured to receive a request, input by a user, for releasing a target conference room, wherein the request carries attribute information of the target conference room, and the target conference room is in a booked state, and wherein the attribute information may be a name, a room number, or the like of the conference room.

The resource determining unit is configured to determine the corresponding target conference room according to the attribute information. The resource determining unit may determine the target conference room according to identification information in the attribute information, or determine, according to status information in the attribute information, that a conference room in a booked state in a current period of time is the target conference room.

The instruction sending unit is configured to send, to a terminal, an instruction to acquire the number of participants in the target conference room. Whether a conference room is in use can be determined according to the number of participants. Therefore, in the present invention, the instruction sending unit sends, to the terminal, the instruction to acquire the number of participants in the target conference room.

The status information receiving unit is configured to receive the number of participants in the target conference room returned according to the instruction by the terminal.

The resource releasing unit is configured to release the target conference room when determining that the number of participants is zero.

That the number of participants is zero indicates that nobody participates in a conference at the moment, and the resource releasing unit is configured to release the target conference room accordingly, and modify a status, in a conference resource management server, of the resource to an idle state, so that another user makes a booking.

It should be noted that, the number of participants being zero at a moment may be caused by an adjournment or a temporary delay of a conference. Therefore, in the present invention, the resource releasing unit may release the target conference room when determining that the number of participants returned within a predetermined time is zero.

In an enterprise, a conference generally needs to occupy multiple conference rooms. For example, in a video conference between different departments, each department occupies one conference room; in this case, multiple conference rooms communicate with each other and know each other relatively well. Corresponding to this, the resource releasing unit includes a request sending unit configured to, when determining that the number of participants in a first conference room is zero and the number of participants in a second conference room is greater than zero, send a release confirmation request to a terminal corresponding to the second conference room; and a status modifying subunit configured to release the first conference room when a release confirmation instruction from the corresponding terminal is received.

According to the foregoing technical solution, a conference room resource that is not in use is proactively released. In order to enable a user to learn about the information in a timely manner, the apparatus in the present invention further includes a prompt information pushing unit configured to push prompt information to a terminal user, where the prompt information includes information about the released conference room resource and is used to query whether the terminal user books the released conference room resource; and a resource allocating unit configured to allocate the conference room resource to the terminal user according to confirmation information returned by the terminal user.

In another embodiment, the apparatus further includes a subscription information storage unit configured to store subscription information of the conference room resource, where the subscription information includes at least a subscriber; the prompt information pushing unit is configured to push the prompt information to the subscriber; the resource allocating unit is configured to allocate the conference room resource to the subscriber according to confirmation information returned by the subscriber.

Further, the apparatus in the present invention further includes a priority information storage unit configured to store priority information of the subscriber; the prompt information pushing unit is configured to push the prompt information to the subscriber according to the priority information.

In this regard, the apparatus further includes a priority determining unit configured to determine a priority of the subscriber according to at least one piece of the following information: historical subscription credit of the subscriber, an office distance of the subscriber, and an urgency degree of a conference of the subscriber.

For a specific manner of determining the priority of the subscriber by the priority determining unit, reference may be made to the foregoing method embodiments.

Corresponding to the foregoing methods, Embodiment 5 of the present invention further provides a resource releasing method. Referring to FIG. 5, the method includes the following steps.

S31: A terminal receives an instruction, sent by a resource management server, to acquire a current usage status of a resource.

S32: The terminal acquires current usage status information of the resource according to the instruction.

The terminal may acquire the current usage status information of the resource in at least one of the following manners: image recognition, voice recognition, access control information, and information automatically input by a user.

The following uses a conference room resource as an example to describe the foregoing several manners.

Image Recognition

Most existing conference rooms in an enterprise are video conference rooms and are mounted with cameras. Therefore, the terminal may acquire a human image by using a camera, perform image recognition on the human image, and then identify the number of participants.

Voice Recognition

The terminal may acquire voice information of participants by using a voice apparatus, perform recognition on the voice information, and then identify the number of participants.

In addition, the terminal may also retain a most recent recording time of voice of a participant. When learning, by means of a query, that the terminal does not record voice for a period of time, the resource management server determines that the number of participants is zero, and then releases a conference room.

Access Control Information

Participants generally need access control cards to enter a conference room; the terminal may determine, according to access control information, whether there is a participant entering the conference room, thereby obtaining the number of participants.

Information Automatically Input by a User

The terminal may acquire the number of participants by using attendance confirmation information automatically input by the participants. For example, each participant that is present in a conference inputs a name and an attendance time on the terminal, and inputs the name and a departure time on the terminal when leaving. In this way, the terminal may obtain the number of participants according to the attendance information and the departure information input by the participants. When there is no related information that is input, it is considered by default that there is no participant.

The image recognition and the voice recognition are generally applicable to a video conference room, and the access control information and the information automatically input by a user are generally used in a non-video conference room.

S33: The terminal sends the current usage status information to the resource management server, so that the resource management server releases the resource when determining, according to the current usage status information, that the resource is not in use.

In the present invention, releasing refers to setting a resource to be in an idle state. The resource management server may set, on a resource management platform, a status of the resource to the idle state. In this way, the user may book the resource.

In this embodiment of the present invention, when the resource is the conference room resource, the instruction, sent by the resource management server and received by the terminal, to acquire the current usage status of the resource, is an instruction to acquire the number of participants in a target conference room. The current usage status information, acquired according to the instruction and received by the terminal, of the resource is the number of participants in the target conference room. The resource management server releases the target conference room when determining that the number of participants is zero.

When there are at least two target conference rooms, the method further includes receiving, by the terminal, a release confirmation request sent by the resource management server, where the release confirmation request is sent when the resource management server determines that the number of participants in a first conference room is zero and the number of participants in a second conference room is greater than zero; and sending, by the terminal, a release confirmation instruction, to the resource management server, so that the resource management server releases the first conference room according to the release confirmation instruction.

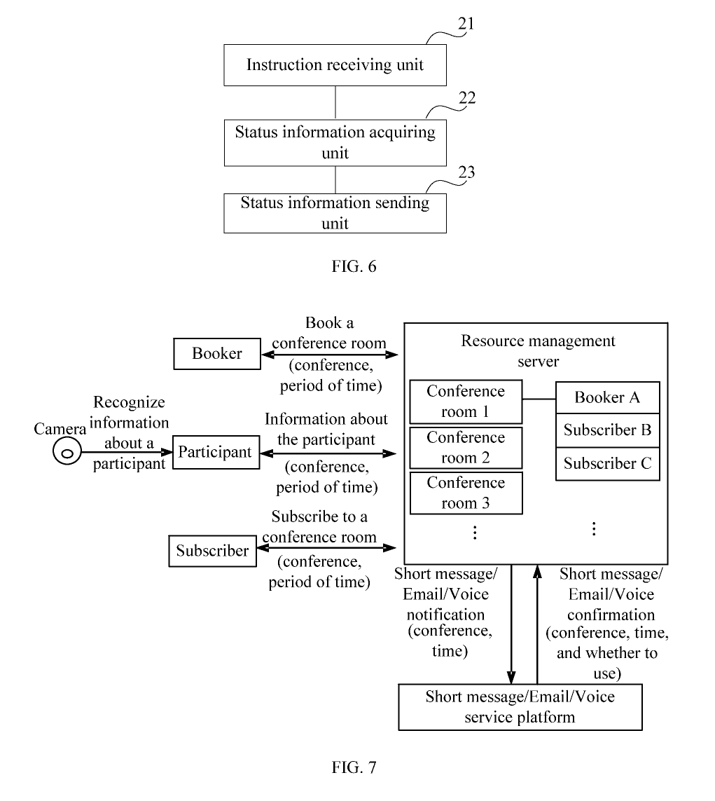

Corresponding to the foregoing method, Embodiment 6 of the present invention provides a resource releasing apparatus. Referring to FIG. 6, the apparatus includes an instruction receiving unit 21 configured to receive an instruction, sent by a resource management server, to acquire a current usage status of a resource; a status information acquiring unit 22 configured to acquire current usage status information of the resource according to the instruction, wherein the status information acquiring unit is configured to acquire the current usage status information of the resource in at least one of: image recognition, voice recognition, access control information, and information automatically input by a user; and for specific implementation, reference may be made to the descriptions in the foregoing method embodiment; and a status information sending unit 23 configured to send the current usage status information to the resource management server, so that the resource management server releases the resource when determining, according to the current usage status information, that the resource is not in use.

When the resource is a conference room resource, the instruction receiving unit is configured to receive an instruction, sent by the resource management server, to acquire the number of participants in a target conference room.

The status information acquiring unit is configured to acquire the number of participants in the target conference room according to the instruction.

The status information sending unit is configured to send the number of participants in the target conference room to the resource management server.

When there are at least two target conference rooms, the apparatus further includes a request receiving unit configured to receive a release confirmation request sent by the resource management server, where the release confirmation request is sent when the resource management server determines that the number of participants in a first conference room is zero and the number of participants in a second conference room is greater than zero; and an instruction sending unit configured to send a release confirmation instruction to the resource management server, so that the resource management server releases the first conference room according to the release confirmation instruction.

Corresponding to the foregoing methods and apparatuses, an embodiment of the present invention provides a resource releasing system, and the system includes a terminal and a resource management server.

The resource management server is configured to send, to the terminal, an instruction to acquire a current usage status of a resource; and further configured to receive current usage status information returned according to the instruction by the terminal, and release the resource when determining, according to the current usage status information, that the resource is not in use.

Considering situations such as an adjournment, in the present invention, the resource management server is configured to release a target conference room when determining that, within a preset period of time, the number of participants is zero.

The terminal is configured to receive the instruction, sent by the resource management server, to acquire the current usage status of the resource; and further configured to acquire the current usage status information of the resource according to the instruction, and send the current usage status information to the resource management server.

The terminal may acquire the current usage status information of the resource in at least one of the following manners: image recognition, voice recognition, access control information, and information automatically input by a user.

The resource management server in the present invention is further configured to push prompt information to a terminal user, and allocate the resource to the terminal user according to confirmation information returned by the terminal user, where the prompt information is used to query whether the terminal user books the released resource.

Further, the resource management server in the system is further configured to store subscription information of the resource, where the subscription information includes at least a subscriber; the resource management server is configured to push the prompt information to the subscriber, and allocate the resource to the subscriber according to confirmation information returned by the subscriber.

Still further, the resource management server is further configured to store priority information of the subscriber, and push the prompt information to the subscriber according to the priority information.

When the resource is a conference room resource, the resource management server is further configured to determine a priority of the subscriber according to at least one piece of the following information: historical subscription credit of the subscriber, an office distance of the subscriber, and an urgency degree of a conference of the subscriber.

When the resource is a conference room resource, the resource management server is configured to send, to the terminal, an instruction to acquire the number of participants in the target conference room; receive the number of participants in the target conference room returned according to the instruction by the terminal; and release the target conference room when determining that the number of participants is zero.

When the resource is a conference room resource, the terminal is configured to acquire the number of participants in the target conference room according to the instruction, sent by the resource management server, to acquire the number of participants in the target conference room; and send the number of participants to the resource management server.

When there are at least two target conference rooms, the resource management server is configured to, when determining that the number of participants in a first conference room is zero and the number of participants in a second conference room is greater than zero, send a release confirmation request to a terminal corresponding to the second conference room; and configured to release the first conference room when a release confirmation instruction from the terminal is received.

Correspondingly, the terminal is configured to receive the release confirmation request sent by the resource management server and send the release confirmation instruction to the resource management server.

Further, this embodiment of the present invention provides hardware composition of the resource management server, which may include at least one processor (for example, a central processing unit (CPU)), at least one network interface or another communications interface, a memory, and at least one communications bus, where the communications bus is configured to implement connection and communication between these apparatuses. The processor is configured to execute an executable module, such as a computer program, stored in the memory. The memory may include a high-speed random access memory (RAM), or may further include a non-volatile memory, for example, at least one magnetic disk memory. The at least one network interface (which may be wired or wireless) may be configured to implement communication and connection between a gateway of the system and at least one other network element by using the Internet, a wide area network, a local area network, a metropolitan area network, or the like.

In some implementation manners, the memory stores a program instruction, where the program instruction may be executed by the processor, and the program instruction may include an instruction sending unit, a status information receiving unit, and a resource releasing unit, or the program instruction may further include a prompt information pushing unit, a resource allocating unit, a subscription information storage unit, a priority information storage unit, and a priority determining unit. For specific implementation of each unit, reference may be made to a corresponding unit in Embodiments 3 and 4 of the present invention, and details are not described herein again.

Still further, this embodiment of the present invention provides hardware composition of the terminal, which may include at least one processor (for example, a CPU), at least one network interface or another communications interface, a memory, and at least one communications bus, where the communications bus is configured to implement connection and communication between these apparatuses. The processor is configured to execute an executable module, such as a computer program, stored in the memory. The memory may include a high-speed RAM, or may further include a non-volatile memory, for example, at least one magnetic disk memory. The at least one network interface (which may be wired or wireless) may be configured to implement communication and connection between a gateway of the system and at least one other network element by using the Internet, a wide area network, a local area network, a metropolitan area network, or the like.

In some implementation manners, the memory stores a program instruction, where the program instruction may be executed by the processor, and the program instruction may include an instruction receiving unit, a status information acquiring unit, and a status information sending unit, or the program instruction may further include a request receiving unit and an instruction sending unit. For specific implementation of each unit, reference may be made to a corresponding unit in Embodiment 6 of the present invention, and details are not described herein again.

Based on the descriptions of the foregoing implementation manners, a person skilled in the art may clearly understand that all or part of steps of the methods in the foregoing embodiments may be implemented by software in addition to a necessary universal hardware platform. Based on such an understanding, the technical solutions of the present invention essentially or the part contributing to the prior art may be implemented in a form of a software product. The computer software product may be stored in a storage medium, such as a read-only memory (ROM)/RAM, a magnetic disk, or an optical disc, and includes several instructions for instructing a computer device (which may be a personal computer, a resource management server, a network communications device such as a media gateway, or the like) to perform the methods described in the embodiments of the present invention or some parts of the embodiments.

It should be noted that the embodiments in this specification are all described in a progressive manner, for same or similar parts in the embodiments, reference may be made to these embodiments, and each embodiment focuses on a difference from other embodiments. Especially, device and system embodiments are basically similar to a method embodiment, and therefore are described briefly; for related parts, reference may be made to partial descriptions in the method embodiment. The described device and system embodiments are merely exemplary. The units described as separate parts may or may not be physically separate, and parts displayed as units may or may not be physical units, and may be located in one position, or may be distributed on a plurality of network units. Some or all of the modules may be selected according to actual needs to achieve the objectives of the solutions of the embodiments. A person of ordinary skill in the art may understand and implement the embodiments of the present invention without creative efforts.

The foregoing descriptions are merely exemplary embodiments of the present invention, but are not intended to limit the protection scope of the present invention. Any modification, equivalent replacement, or improvement made without departing from the spirit and principle of the present invention shall fall within the protection scope of the present invention.

What is claimed is:

1. A resource releasing method, comprising:
determining, by a resource management server, a resource that is in a booked state;
sending, by the resource management server to a terminal, an instruction to acquire a current usage status of the resource;
receiving, by the resource management server, current usage status information returned according to the instruction by the terminal; and
releasing, by the resource management server, the resource when it is determined, according to the current usage status information, that the resource is not in use.

2. The method according to claim 1, wherein before determining, by the resource management server, the resource that is in the booked state, the method further comprises receiving, by the resource management server, a resource release request, wherein the request carries attribute information of the resource which indicates that the resource is in the booked state, and wherein determining, by the resource management server, the resource that is in the booked state comprises determining, by the resource management server, the resource that is in the booked state according to the attribute information.

3. The method according to claim 1, further comprising:
pushing, by the resource management server, prompt information to a terminal user, wherein the prompt information is used to query whether the terminal user books the released resource; and
allocating, by the resource management server, the resource to the terminal user according to confirmation information returned by the terminal user.

4. The method according to claim 3, wherein the resource management server stores subscription information of the resource, wherein the subscription information comprises a subscriber, wherein pushing, by the resource management server, prompt information to the terminal user includes pushing, by the resource management server, the prompt information to the subscriber, and wherein allocating, by the resource management server, the resource to the terminal user according to confirmation information returned by the terminal user includes allocating, by the resource management server, the resource to the subscriber according to confirmation information returned by the subscriber.

5. The method according to claim 4, wherein the resource management server stores priority information of the subscriber, and wherein pushing, by the resource management server, the prompt information to the subscriber includes pushing, by the resource management server, the prompt information to the subscriber according to the priority information.

6. The method according to claim 1, wherein sending, by the resource management server to the terminal, the instruction to acquire the current usage status of the resource includes sending, by the resource management server to the terminal, an instruction to acquire the number of participants in a target conference room, wherein receiving, by the resource management server, current usage status information returned according to the instruction by the terminal includes receiving, by the resource management server, the number of participants in the target conference room returned according to the instruction by the terminal, and wherein releasing, by the resource management server, the resource when it is determined, according to the current usage status information, that the resource is not in use includes releasing, by the resource management server, the target conference room when it is determined that the number of participants is zero.

7. The method according to claim 6, wherein releasing the target conference room when it is determined that the number of participants is zero comprises releasing the target conference room when it is determined that, within a preset period of time, the number of participants is zero.

8. The method according to claim 6, wherein there are at least two target conference rooms, and wherein releasing the target conference room when it is determined that the number of participants is zero comprises:
sending, when it is determined that the number of participants in a first conference room is zero and the number of participants in a second conference room is greater than zero, a release confirmation request to a terminal corresponding to the second conference room; and
releasing the first conference room when a release confirmation instruction from the corresponding terminal is received.

9. The method according to claim 5, wherein, when the resource is a conference room resource, the method further comprises determining, by the resource management server, a priority of the subscriber according to at least one piece of the following information: historical subscription credit of the subscriber, an office distance of the subscriber, and an urgency degree of a conference of the subscriber.

10. The method according to claim 1, wherein the current usage status information of the resource is obtained by the terminal in at least one of the following manners: image recognition, voice recognition, access control information, and information input by a user.

11. A resource releasing apparatus comprising:
a processor; and
a non-transitory computer readable medium which contains computer-executable instructions, wherein the processor is configured to execute the computer-executable instructions to perform operations comprising:
determining a resource that is in a booked state;
sending to a terminal an instruction to acquire a current usage status of the resource;
receiving current usage status information returned according to the instruction by the terminal; and
releasing the resource when it is determined, according to the current usage status information, that the resource is not in use.

12. The resource releasing apparatus according to claim 11, wherein before the operation of determining the resource that is in the booked state, the processor is configured to execute the computer-executable instructions to perform another operation comprising receiving a resource release request, wherein the request carries attribute information of the resource which indicates that the resource is in the booked state, and wherein the operation of determining the resource that is in the booked state comprises determining the resource that is in the booked state according to the attribute information.

13. The resource releasing apparatus according to claim 11, wherein the processor is configured to execute the computer-executable instructions to perform further operations comprising:
pushing prompt information to a terminal user, wherein the prompt information is used to query whether the terminal user books the released resource; and
allocating the resource to the terminal user according to confirmation information returned by the terminal user.

14. The resource releasing apparatus according to claim 13, wherein the non-transitory computer readable medium further stores subscription information of the resource, wherein the subscription information comprises a subscriber, wherein the operation of pushing prompt information to the terminal user comprises pushing the prompt information to the subscriber, and wherein the operation of allocating the resource to the terminal user according to confirmation information returned by the terminal user comprises allocating the resource to the subscriber according to confirmation information returned by the subscriber.

15. The resource releasing apparatus according to claim 14, wherein the non-transitory computer readable medium further stores priority information of the subscriber, and wherein the operation of pushing the prompt information to the subscriber comprises pushing the prompt information to the subscriber according to the priority information.

16. The resource releasing apparatus according to claim 11, wherein the operation of sending to the terminal, the instruction to acquire the current usage status of the resource comprises sending to the terminal an instruction to acquire the number of participants in a target conference room, wherein the operation of receiving current usage status information returned according to the instruction by the terminal comprises receiving the number of participants in the target conference room returned according to the instruction by the terminal, and wherein the operation of releasing the resource when it is determined, according to the current usage status information, that the resource is not in use comprises releasing the target conference room when it is determined that the number of participants is zero.

17. The resource releasing apparatus according to claim 16, wherein the operation of releasing the target conference room when it is determined that the number of participants is zero comprises releasing the target conference room when it is determined that, within a preset period of time, the number of participants is zero.

18. The resource releasing apparatus according to claim 16, wherein there are at least two target conference rooms, and wherein the operation of releasing the target conference room when it is determined that the number of participants is zero comprises:
sending, when it is determined that the number of participants in a first conference room is zero and the number of participants in a second conference room is greater than zero, a release confirmation request to a terminal corresponding to the second conference room; and
releasing the first conference room when a release confirmation instruction from the corresponding terminal is received.

19. The resource releasing apparatus according to claim 15, wherein, when the resource is a conference room resource, the processor is configured to execute the computer-executable instructions to perform further operations comprising determining a priority of the subscriber according to at least one piece of the following information: historical subscription credit of the subscriber, an office distance of the subscriber, and an urgency degree of a conference of the subscriber.

20. A resource releasing system, wherein the system comprises:
a terminal; and
a resource management server configured to:
determine a resource that is in a booked state;
send to a terminal, an instruction to acquire a current usage status of the resource;
receive current usage status information returned according to the instruction by the terminal; and
release the resource when it is determined, according to the current usage status information, that the resource is not in use, and
wherein the terminal is configured to:
receive the instruction, sent by the resource management server, to acquire the current usage status of the resource; and
acquire the current usage status information of the resource according to the instruction and send the current usage status information to the resource management server.
